(19) United States
(12) Patent Application Publication
(10) Pub. No.: US 2015/0358425 A1
(43) Pub. Date: Dec. 10, 2015

(54) Processing Data Streams

(71) Applicant: HEWLETT-PACKARD DEVELOPMENT COMPANY, L.P., Houston, TX (US)

(72) Inventors: RAVIGOPAL VENNELAKANTI, PALO ALTO, CA (US); SANGAMESH BELLAD, PALO ALTO, CA (US); PRASUN SINGH, PALO ALTO, CA (US)

(21) Appl. No.: 14/762,740

(22) PCT Filed: Jan. 22, 2013
(86) PCT No.: PCT/US13/22585

§ 371 Date: Jul. 22, 2015

(51) Int. Cl. H04L 29/08; H04L 12/911

(52) U.S. Cl. CPC H04L 67/32; H04L 47/823

(57) ABSTRACT

A method for processing data streams comprises receiving a multiplexed data stream from a number of sources, the sources comprising a number of sensors and a number of vibroseis trucks to stimulate an environment in which the sensors are deployed, processing the data stream using a number of operators, with the operators, utilizing a number of compute resources to process the data stream, and with a data flow graph and scheduler module, scaling the number of compute resources used to process the data stream.

### BACKGROUND

In certain systems, data may be received by a processing device from a number of peripheral sensor devices on a continual, periodic basis. The sensor devices may be distributed through a wide area, and are used to detect parameters of interest in order to provide information to a user about the environment in which the sensor devices are deployed. The output of a sensor device may be sampled on a periodic basis and written to a cache of the processing device, where the processing device can then access and manage the data according to a particular application. This type of continuously updated raw data may be referred to as a data stream. Depending on the rate that data is received from peripheral sensor devices, the format of the data, and the number of peripheral sensor devices contributing to the stream, the amount of data transmitted in a stream can vary considerably, and in some cases can be extremely large.

### BRIEF DESCRIPTION OF THE DRAWINGS

The accompanying drawings illustrate various examples of the principles described herein and are a part of the specification. The illustrated examples are given merely for illustration, and do not limit the scope of the claims.

FIG. 1 is a diagram of a seismic sensing system, according to one example of the principles described herein.

FIG. 2 is a block diagram and data flow of a stream data processing system, according to one example of the principles described herein.

FIG. 3 is a flowchart showing a method for processing data streams, according to one example of the principles described herein.

Throughout the drawings, identical reference numbers designate similar, but not necessarily identical, elements.

### DETAILED DESCRIPTION

With increasing bandwidth capabilities in electronic devices, data streams in modern systems may transmit large amounts of data. In many situations, the information in a data stream may be used to make quick decisions in real-time that affect a number of other operations of the device processing the stream, a related business, or a related task to be performed by a number of users in connection with the distributed sensor devices. Thus, it is often desirable for a device to process a received data stream as quickly and efficiently as possible in order to better serve customers in the business or positively affect a number of users of the distributed sensor devices.

As described above, distributed sensor systems may be used to collect data about the environment in which the sensors are deployed. One type of sensor is called a geophone; a wired device which converts ground movement into voltage to produce an analog signal. Systems that utilize geophones have limited accuracy. Further, geophone systems are difficult to deploy and redeploy and are difficult to scale as only 100,000 geophones may be deployed at a time. Geophone systems are connected to wired node systems whose deployment scalability in the field is limited due to its wired nature that imposes logistical problems in deploying them in a large survey area spanning thousands of square kilometers.

It is also the case that utilizing a distributed sensor system across a wide area precludes the luxury of placing an enterprise-scale or cloud-scale system in the field due to the lack of logistics in areas in which the sensor system is deployed. For example, distributed sensor systems used in oil and gas exploration are placed in extremely rural areas such as deserts and tundras, and across large areas of land. This makes utilization of enterprise-scale or cloud-scale systems difficult or impossible.

The present systems and methods utilize wireless, digital sensor devices that may be deployed at a relatively larger scale: approximately one million sensor devices or more at a time. In one survey design, the system may have approximately one million sensors spread over a 40×18.4 km² area, connected wirelessly to a command center. Based on specific survey plan options selected, each day 24,000 to 100,000 sensors will be retrieved from one side of the survey grid or target area, and redeployed to the other side of the survey area, so as to cover a total acreage of 40×40 km² during the surveying project.

Thus, the present systems and methods provide a land-based seismic imaging system for, among other applications, oil and gas exploration through the use of a mega channel system for the acquisition of seismic data and field management of that data. The system further provides a centralized monitoring and controlling system in an in-field, mobile command center that provides field storage and processing of data to ensure that the deployed sensor array is functioning properly and capturing seismic data accurately and precisely.

The present disclosure, therefore describes a method for processing data streams comprising receiving a multiplexed data stream from a number of sources, the sources comprising a number of sensors and a number of vibroseis trucks to stimulate an environment in which the sensors are deployed. The method also processes the data stream using a number of operators, and, with the operators, utilizing a number of compute resources to process the data stream. The method also, with a data flow graph and scheduler module, scales the number of compute resources used to process the data stream.

Further, a system for stream data processing is described. The system comprises a sensor array to produce a number of data streams, the sensor array comprising a number of sensors, and the data streams comprising data associated with seismic activity and vibroseis truck vibrations detected by the sensors. The system further comprises a number of operators to process the data streams, a number of compute resources utilized by the operators to process the data streams; and a data flow graph and scheduler module to scale the number of compute resources utilized by the operators to process the data streams.

Still further, the present disclosure describes a computer program product for processing data streams. The computer program product comprises a computer readable storage medium comprising computer usable program code embodied therewith. The computer usable program code comprises computer usable program code to, when executed by a processor, instruct a number of operators to process a number of data streams obtained from a sensor array, the sensor array comprising a number of sensors, and the data streams comprising data associated with seismic activity and vibroseis truck vibrations detected by the sensors, computer usable program code to, when executed by a processor, instruct the operators to utilize a number of general-purpose computing on graphics processing units (GPGPUs) to process the data streams, and computer usable program code to, when executed by a processor, scale the number of GPGPUs used to process the data streams.

The present systems and methods are, therefore, able to capture data from a deployed sensor array, analyze the data, and provide real time or near real time information. The real time or near real time information may be information regarding, for example, the health of the deployed sensor array, whether individual sensors in the sensor array are functioning properly, whether the quality of the data recorded on individual nodes is high enough, whether the sensors are collecting the correct type of data, which sensors are collecting data, and whether enough sensors are collecting data, among other types of information. This makes it possible for the operators of the sensor survey to achieve the goals set forth by, for example, a service level agreement (SLA).

As used in the present specification and in the appended claims, the term “structured data” is meant to be understood broadly as any data that is identifiable because it is organized in a structure. For example, structure data may be data that resides in fixed fields within a record or file such as relational databases and spreadsheets. In one example, the structure data may be searchable by data type within the content. In contrast, as used in the present specification and in the appended claims, the term “unstructured data” is meant to be understood broadly as any data that has no identifiable structure. For example, images, videos, email, documents, and text may be considered to be unstructured data within a dataset.

As used in the present specification and in the appended claims, the terms “mega-channel,” “mega-channel sensor system,” “multiplexed data stream,” or similar language is meant to be understood broadly as any computing process or system whereby multiple sets of data from different sources (i.e. channels) are linked and/or housed together and then analyzed to provide information about the multiple sets of data. This provides effective and successful decision-making information to an administrator. In one example, the different sources from which the multiple sets of data are obtained may comprise a number of sensors distributed in a wide area, a base camp where processing of data occurs, a command center where the survey process is controlled, a number of vibroseis trucks used to stimulate the environment in which the sensors are deployed, and a number of personnel working on the survey and their computing devices. Further, the different sources from which the multiple sets of data are obtained may comprise a number of applications that are running within the survey system such as, for example, a crew management application, a resource management application, health safety applications, agency applications, and combinations thereof. Still further, the sources may comprise information provided by any other source that provides update information regarding the above sources. In another example, the different sources from which the multiple sets of data are obtained may comprise any combination of the foregoing.

In the example of the sensors, the number of sensors may range from one sensor to approximately one million sensors. In one example, each individual sensor may provide more than one type or channel of information.

Even still further, as used in the present specification and in the appended claims, the term “a number of” or similar language is meant to be understood broadly as any positive number comprising 1 to infinity; with zero indicating the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

Further, in the following description, the example of a number of seismic sensor devices distributed on land within a wide area is presented in order to provide a thorough understanding of the present systems and methods. However, any distributed sensor system deployed in any environment may be used in connection with the stream data processing systems and methods described herein. The peripheral sensor devices that make up the distributed sensor system may be any type of sensor that may gather any type of data associated with the environment in which the sensor devices are deployed. The sensors of the present specification may be any data producing device or other apparatus or system that provides a measurement or digital data to a receiving device. The data producing device may transmit the data directly to the receiving device, provide the data at a node that is sampled by the receiving device, or a combination thereof. The data may include an analog measurement, a digital sequence of bits, or a combination thereof. These distributed sensor systems may be utilized in any context.

For example, the sensors and the systems of the present application may be deployed in the health care industry. In this example, the sensors may be deployed to sense and monitor a number of vital signs of a number of health care patients. Another example in which the present systems and methods may be deployed includes monitoring of infrastructure such as roads, bridges, water supplies, sewers, electrical grids, and telecommunications among others. Still another example may be the monitoring of various components of a vehicle such as an airplane. Still another example in which the present systems and methods may be deployed comprises the monitoring of brainwaves. Thus, although the presented systems and methods have application in almost any area of data acquisition and analysis, the present disclosure will describe these systems and methods in the context of a number of seismic sensor devices distributed on land within a wide area.

Throughout the present disclosure, various computing elements and devices are used in connection with the collection, analysis, and visualization of large amounts of data obtained from a distributed sensor array. To achieve its desired functionality, the system (100) comprises various hardware components. Among these hardware components may be a number of sensors, a number of processing devices, a number of data storage devices, a number of peripheral device adapters, and a number of network adapters, among other types of computing devices. In one example, these hardware components may be interconnected through the use of a number of busses and/or network connections. In another example, the hardware components may make up a single overall computing device or system. In still another example, the hardware components may be distributed among a number of computing devices that are interconnected through the use of a number of busses and/or network connections.

The present systems described herein may comprise a number of computer processing devices. The computer processing devices may include the hardware architecture to retrieve executable code from a data storage device and execute the executable code. The executable code may, when executed by the computer processing devices, cause the computer processing devices to implement at least the functionality of receiving and processing a number of data streams obtained from a deployed sensor array, according to the methods of the present specification described herein. In the course of executing code, the computer processing devices may receive input from and provide output to a number of the remaining hardware units.

The data storage devices described herein may store data such as executable program code that is executed by the computer processing devices. As will be discussed, the data storage devices may specifically store a number of applications that the computer processing devices execute to implement at least the functionality described above.

The data storage devices may include various types of memory modules, including volatile and nonvolatile memory. For example, the data storage devices may include Random Access Memory (RAM), Read Only Memory (ROM), and Hard Disk Drive (HDD) memory. Many other types of memory may also be utilized, and the present specification contemplates the use of many varying type(s) of memory in the data storage devices as may suit a particular application of the principles described herein. In certain examples, different types of memory in the data storage devices may be used for different data storage needs. For example, in certain examples the computer processing devices may boot from Read Only Memory (ROM), maintain nonvolatile storage in the Hard Disk Drive (HDD) memory, and execute program code stored in Random Access Memory (RAM).

The data storage devices described herein may comprise a computer readable storage medium. For example, the data storage devices may be, but are not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an Instruction execution system, apparatus, or device. In another example, a computer readable storage medium may be any non-transitory medium that can contain, or store a program for use by or in connection with an instruction execution system, apparatus, or device.

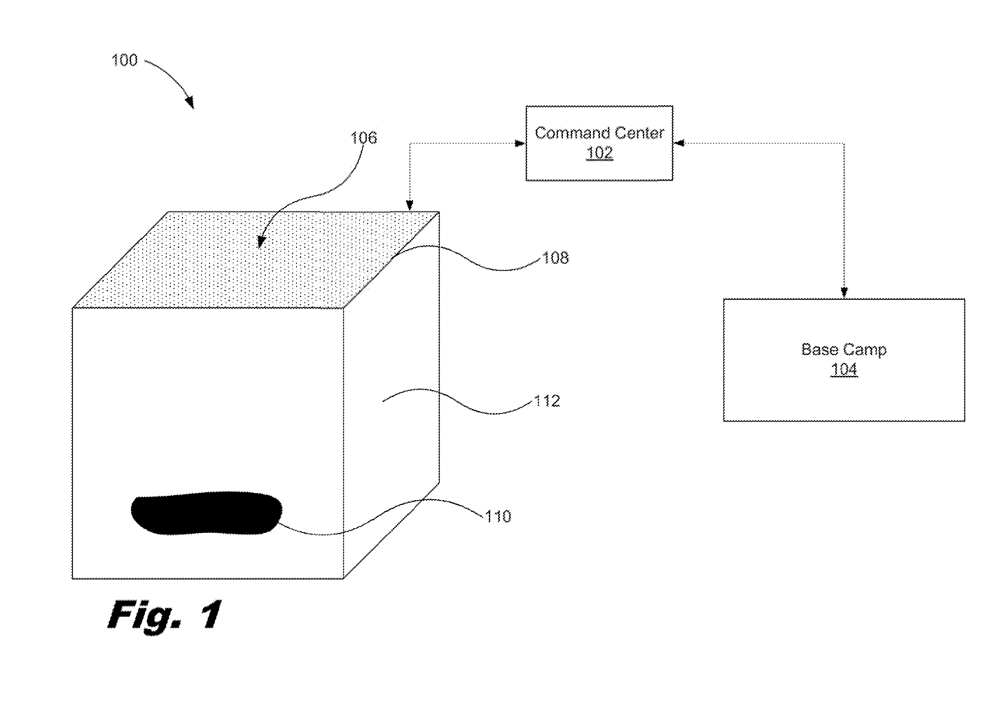

Turning now to the figures, FIG. 1 is a diagram of a seismic sensing system (100), according to one example of the principles described herein. The seismic sensing system (100) comprises a command center (102), and base camp (104), and an array of sensors (106) distributed within a target area (108). In one example, the seismic sensing system (100) is used to detect the presence of a desired resource (110) such as oil or gas within the geological features in which the seismic sensing system (100) is deployed.

The command center (102) may be located relatively closer to the target area (108) than the base camp (104), and the computing devices within the command center (102) are used to monitor the daily activities performed at the target area (108) and process data representing the environmental information detected and transmitted by the sensor array (106), as will be described in more detail below.

The base camp (104) may be located relatively further from the target area (108) than the command center (102). The base camp (104) also comprises a number of computing devices that, among other activities, process the data representing the environmental information detected and transmitted by the sensor array (106), and produce information useful to the exploration of the resource (110) within a subterranean area (112) of the land. This information may include, for example, information regarding the location of the desired resource (110) within the subterranean area (112), and potential drilling paths to obtain the resource (110), among others.

The sensor array (106) distributed within a target area (108) is used to directly or indirectly detect the resource (110). The sensor array (106) is made up of any number of sensor devices that detect any number of environmental or physical quantities, and convert it into a signal which can be interpreted by a computing device. In one example, the sensor array (106) comprises any number of sensors. In another example, the number of sensors within the sensor array (106) is between one and one million sensors. In still another example, the number of sensors within the sensor array (106) is greater than one million sensors. In still another example, the sensor array (106) comprises approximately one million sensors. In the example of approximately one million sensors, the sensors may be uniformly or non-uniformly distributed throughout the target area (108). In one example, the approximately one million sensors are distributed uniformly within the target area (108) in an approximately grid manner by dividing the target area (108) into enough subsections to provide approximately one million vertices within the target area (108) at which the approximately one million sensors are paced.

In one example, the target area (108) has an area of approximately 1,600 square kilometers, and the approximately one million sensors are spread over the 1,600 square kilometer area. Operating and supporting such a big survey is an unprecedented task. As will be described in more detail below, the technical approach reflects a focus on real or near real time analytics. In the present specification and in the appended claims, the term “real time analytics,” “near real time analytics,” or similar language is meant to be understood as analysis of data within approximately 15 seconds or less. Receiving large amounts of data from the above-described sensor array, analyzing that data in real time or near real time, and presenting a visualization of that data to an administrator may be difficult. Thus, there are challenges associated with these types of field operations. The present systems and methods provide for stream data analytics that manage a mega-channel sensor system for, for example, seismic data acquisition. Thus, the data streamed into the present system may be a multiplexed data stream from a number of sources as described above.

Data received from the sensor array (106) may be structured data, unstructured data, or a combination thereof. Further, the data received from the sensor array (106) may be historical data, real-time data, or a combination thereof. Historical data is mined in parallel for trending and pattern detection thereby applying the trends and patterns to real time or near real time data streams. Even still further, the data received from the sensor array (106) may be received as a burst data stream, a continuous data stream, or combinations thereof. Even still further, the data received from the sensor array (106) may be any combination of the foregoing.

In one example, the sensors within the sensor array (106) are analog sensors, digital sensors, or a combination thereof. The individual sensors within the sensor array (106) may be, for example, seismometers that measure seismic waves or other motions of the ground. In another example, the individual sensors within the sensor array (106) may be accelerometers that measure proper acceleration in the x-, y-, and z-axis. In this example, an accelerometer is a microelectromechanical systems (MEMS) based accelerometer. In still another example, the individual sensors within the sensor array (106) may be gravity gradiometers that are pairs of accelerometers extended over a region of space used to detect gradients in the proper accelerations of frames of references associated with those points. In yet another example, the individual sensors within the sensor array (106) may be any other type of sensing device used to detect any other environmental parameter, or combinations of the above examples as well as other types of sensors.

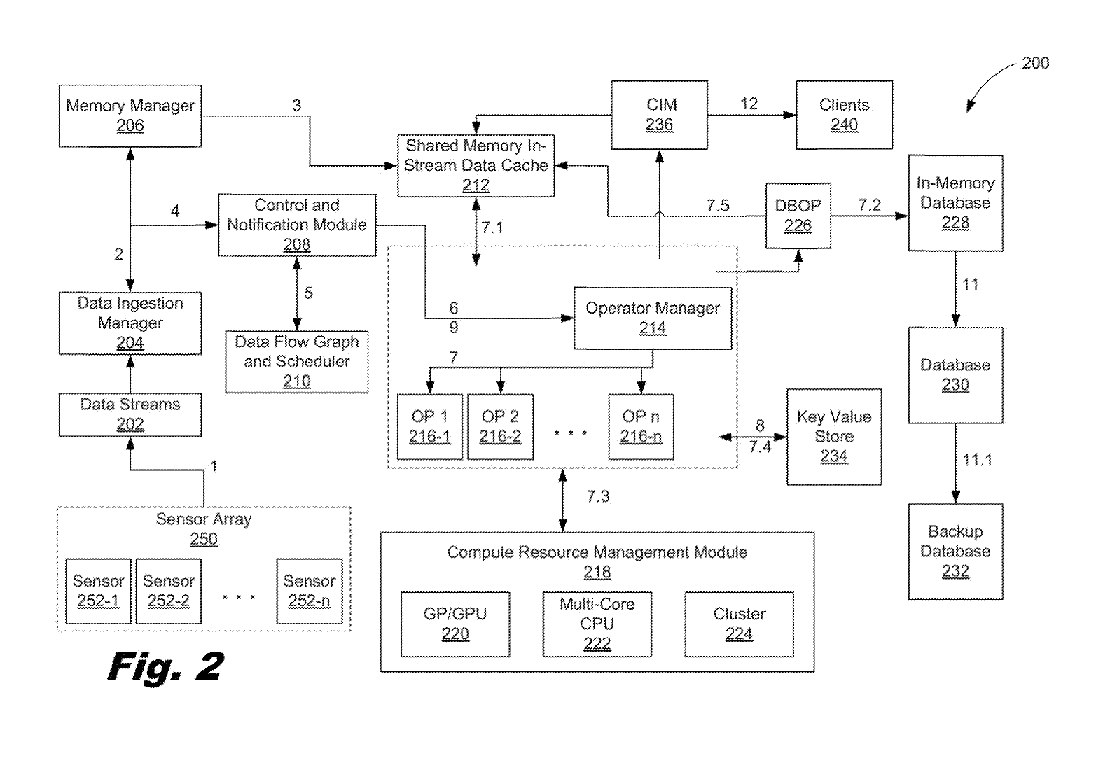

FIG. 2 is a block diagram and data flow of a stream data processing system (200), according to one example of the principles described herein. In one example, the stream data processing system (200) is used within the command center (FIG. 1, 102) in order to provide the administrator of the command center (102) with real-time quality control (QC) metrics. In one example, the QC metrics are tracked, collected, and analyzed by the stream data processing system (200) in order to provide the administrator with a continuous, real-time quality control assessment, alerts, and system health assessments associated with the sensor array (106) and the data received from the sensor array (106).

The real-time information provided by the stream data processing system (200) within the command center (FIG. 1, 102) is used to ensure that the data obtained from the sensor array (106) is reliable and is available in a form for further processing or analysis at, for example, the base camp (104). The system (200) may provide any number of quality control (QC) metrics. Two such types of QC metrics are a system QC metrics and seismic QC metrics. System QC metrics are measured, for example, per 20 second frequency, and provide an administrator with an update on the status of the instrumentation such as the sensors deployed for the survey mechanics. Seismic QC metrics comprise the root mean square (RMS) values and peak amplitude to detect the energy (i.e., signal to noise ratio) in the field. Both the system and seismic QC data amount to 54 MB every 20 seconds.

Further, the system (200) may provide trace data QC metrics that amount to 128 MB every 45 seconds. Trace data QC metrics are aimed at probing target receiver sensor lines comprising 4000 sensor trace data to create shot panels (i.e., stacked traces).

The system (200) may also provide operations logistics metrics. The operations logistics metrics may be either captured or derived metrics to control and monitor operational aspects of the system such as, for example, deployment, retrieval, provisioning, and charging of sensors within the survey project.

As described above, although the data foot print is manageable, these metrics challenge the analytics workloads of the system (200). Other deployment scenarios may present other characteristics of work load models including, for example, high data volumes with large workloads, high data volumes with high speed processing and relatively smaller workloads, small data volumes with large workloads, and small data volumes with high speed processing. The present system and methods deal with real-time and historical data from a unified platform deployed in a field environment setup. The in-field deployment environment presents constraints related to rack-space, power requirements, maintenance, flexibility, and associated compute environment form factors. In one example, the management and control components of the command center (102) system is deployed on a truck sometimes referred to as a “doghouse.” The architecture of the present system is motivated by a scale up architecture model leveraging GPGPUs and multi-core CPUs to run a number of complex analytics algorithms. The system (200) supports deep analytics for comprehensively deriving insights such as, for example, current events, past trends, prognostics, and behaviors over a combined view of live streaming and historical data sets.

Two survey setups of small and big sizes have been experimented with. For small-sized surveys setups, a stack comprising of an object-relational database management system such as the PostgreSQL database system developed by PostgreSQL Global Development Group and offered as open source. The stack in this example also comprises a number of memcached servers. In one example, the PostgreSQL database system comprises a user defined function (UDF) framework that provides methods to run analytics closer to the data source to support continuous query requirements over historical and streaming data. For a larger scale setup involving a mega-channel system, the stack may comprise analytic database management software developed and distributed by Vertica Systems, Inc., a Hewlett-Packard Company, for the data-management functions where columns store data ingestions and high-speed read operations.

Thus, by way of data management, in order to sustain data stream workload processing at the command center (102), evaluation of database systems have been undertaken to estimate the intrinsic significance of each candidate database's characteristics. The above PostgreSQL and Vertica databases have been evaluated as candidates for the streaming analytics and storage performance requirements. Each of the database systems has provided a capability to sustain user defined functions (UDF) that allow addition of custom code to the database for performance or extensibility reasons. UDF gives flexibility to build stream analytical operators in the database system directly. The evaluation for feasibility of harnessing the UDF potential was undertaken for data ingestion and data processing performance in database systems. Some target goals for evaluation using simulated data are to receive more than 54 MB of QC data continuously streamed at intervals of 20 seconds, store the 54 MB of data within 3 seconds (18 Mbps or 144 Mbps) of arrival, and process the data with analytical operators within the following 7 to 10 seconds before the next set of QC data arrives.

This application framework provides a comprehensive tool set to monitor and track the million node sensor network deployment system. The monitoring services interface provided by the above examples enables coarse level access to several monitoring parameters such as, for example, sensor monitoring, network monitoring, storage monitoring, operational parameters monitoring, system integrity checks, system event monitoring, process monitoring, and sensor and network discovery.

Turning again to FIG. 2, the stream data processing system (200) comprises a data ingestion manager (204) that receives (1) data streams (202) from the sensors (252-1, 252-2, 252-n) of the sensor array (250), a number of sensors, a number of applications, a number of personnel, a number of vibroseis trucks, a base camp, and a command center, among others, or combinations thereof as described above. Thus, the data streamed into the present system may be a multiplexed data stream from a number of sources as described above.

In one example, the data received from the sensors (252-1, 252-2, 252-n) is not the total amount of data collected by the sensors (252-1, 252-2, 252-n) during deployment. In this example, the system samples the data being collected by the sensors (252-1, 252-2, 252-n), and analyzes these samples.

Although three sensors (252-1, 252-2, 252-n) are depicted in the sensor array (250) of FIG. 2, any number of sensors (252-1.252-2, 252-n) may be present within the sensor array (250). As described above, approximately one million sensors (252-1, 252-2, 252-n) may be included within the sensor array (250). The received (1) data streams (202) may comprise mixed work loads.

In one example, the sensors are high resolution Richter sensors developed and sold by Hewlett-Packard Company. The Richter sensors are cost-effective, accurate, and high-end inertial measurement units (IMUs) capable of measuring movement on the x-, y-, and z-axis, as well as pitch, roll and yaw, all on a single, homogenous planar chip. Richter sensors provide these six axis of sensing while overcoming the inherent orthogonal inaccuracy produced by other IMUs. Using the Richter sensors or other sensors described herein, the system may be scaled up to approximately ten times the size of previous systems.

The system (200) may receive a number of types of data from the sensor array (250). One such type of data is system health data. The sensors (252-1, 252-2, 252-n) within the sensor array (250) are wireless sensors. Therefore, each of the sensors (252-1, 252-2, 252-n) run on batteries or other wireless forms of energy. Therefore, at least one health parameter of the sensors (252-1, 252-2, 252-n) is the amount of battery power left in the sensors (252-1, 252-2, 252-n). This, and other health parameters of the sensors (252-1, 252-2, 252-n) may be sent to the system (200) for review by an administrator. Knowing the health of the sensors (252-1, 252-2, 252-n), individually and collectively, assists in ensuring that the sensors are collecting data accurately. Thus, the system (200) receives system health data from the sensors (252-1, 252-2, 252-n), and determines that the parameters of the sensors (252-1, 252-2, 252-n) are functioning as expected.

A second type of data received by the system (200) is data associated with the type of sensors (252-1, 252-2, 252-n) deployed and the type of data collected by the sensors (252-1, 252-2, 252-n). In the present example, the sensors (252-1, 252-2, 252-n) collect raw seismic data which is streamed (202) into the system (200) and is, in turn, used to identify a resource (FIG. 1, 110) such as, for example, oil or gas deposits in the subterranean area (FIG. 1, 112). The sensors (252-1, 252-2, 252-n) may be continually recording the seismic data. This recorded seismic data is collected and fully analyzed at the base camp (104).

However, in one example, approximately 45 seconds of seismic data is pulled from the raw recoded seismic data. This portion (45 seconds) of the recorded seismic data is a third type of data, and is used as a quality control to check the quality of seismic data obtained from the sensors (252-1, 252-2, 252-n). If other types of sensors are used, a similar portion of recorded data may also be used to ascertain the quality of data recorded from these other types of sensors. In one example, in order to determine the quality of the data obtained from the sensors (252-1, 252-2, 252-n), the system may obtain and analyze the quality control data within approximately ten seconds of response time. This allows an administrator at the command center (102) to detect if a number of sensors (252-1, 252-2, 252-n) are collecting data as intended or expected, whether there is an anomalous data collection that may indicate a number of malfunctioning sensors (252-1, 252-2, 252-n), or whether a number of sensors (252-1, 252-2, 252-n) are not collecting data or transmitting data to the command center (102). If it is determined that a number of sensors (252-1, 252-2, 252-n) are not functioning property or otherwise not collecting or transmitting data, then a request may be made by the administrator to service or replace those sensors (252-1, 252-2, 252-n) that are not functioning properly or otherwise not collecting or transmitting data.

During the overall seismic survey, a vibroseis truck equipped with a device to create vibrations in the ground may be driven into the target area (108). The truck's ground vibration equipment is used to create seismic activity detectable by the sensors (252-1, 252-2, 252-n). The vibrations caused by the truck's vibration equipment travel into the subterranean area (112) of the land, are reflected from the various layers of the subterranean area (112), and are detected by the sensors (252-1, 252-2, 252-n) as raw seismic data. In one example, the vibration equipment may create vibrations at a predetermined frequency so that an intended detection pattern may be detected by the sensors (252-1, 252-2, 252-n). In this manner, data associated with the characteristics of the subterranean area (112) can be analyzed at the base camp (104), and used to detect the resource (FIG. 1, 110) in the subterranean area (FIG. 1, 112). The quality control data described above is pulled from this raw seismic data, analyzed at the command center (102), and used to determine if the data being obtained from the sensors (252-1, 252-2, 252-n) is precise and/or accurate.

In one example, the location of the vibroseis truck within the target area (108) may be tracked in order for the system (FIG. 2, 200) to correlate the source of the vibrations with the location of the vibroseis truck and the sensors (106). In another example, the frequency and intensity of the vibrations created by the vibroseis truck may be predetermined or known so that the system (FIG. 2, 200) can correlate the detected frequency and Intensity of the vibrations detected by the sensors (106) with those produced by the vibroseis truck.

In one example, the raw seismic data obtained from the sensors (252-1, 252-2, 252-n) may, itself, contain a number of different streams of data (202). For example, the raw seismic data may comprise the above-described streaming data. The streaming data (202) comprises real-time data sent from the sensors (252-1, 252-2, 252-n) in the sensor array (250). The raw seismic data may also comprise historical data. The historical data is data that has been collected by the sensors (252-1, 252-2, 252-n) and stored for later transmission to the system (200) or other computing devices. Any number of additional data streams (202) may be communicated from the sensor array (250) to the system (200) as may fit a particular scenario.

The data streams (202) that are received by the data ingestion manager (204) may comprise mixed work loads. These data streams (202) are heterogeneous in the data type and the work load. For example, the system may prioritize for certain types of data such as, for example, prioritizing first for the collection and analysis of the data associated with the system health, and then prioritizing second for the collection and analysis of the data associated with quality control data of the raw seismic data. In this manner, the data ingestion manager (204) prioritizes the various data streams (202) that are received by the system (200), and sends the prioritized data to other components within the system (200) such as the memory manager (206). Prioritization of data streams by the data ingestion manager (204) may be achieved through, for example, the use of rules-based processing.

The memory manager (206) allocates a number of types of memory structures to which the data is to be stored and controls how the memory is to be utilized in later processing. For example, the memory manager (206) may designate the shared memory in-stream data cache (212) located on a single server as the memory structure. In another example, the memory manager (206) may allocate a number of servers across which the data is distributed. In one example, the memory manager (206) may write data to a buffer (3) before writing data to a memory structure that has been allocated by the memory manager (206).

In one example, the memory manager (206) utilizes quota-based memory management, and calculates the memory quota needed by each data source using cache size and block size parameters. The memory manager (206) allocates space for each data source to store blocks based on a MAX_BLOCKS parameter, and tracks a memory map of each data stream (202) which comprises the start position, end position, and the current position where the next block can be written using a cyclic, arrival time based first in, first out (FIFO) logic. In this example, new data introduced to the system (200) overwrites the oldest data if the buffer is full. A sample configuration for the memory manager (206) is illustrated in Table 1.

TABLE 1
Memory Manager Configuration

| DATA_SOURCE | MAX_BLOCK_SIZE | | MAX_TUPPLE_SIZE | MAX_BLOCKS | MAX_QUOTA |
|---|---|---|---|---|---|
| QC_DATA | 54 | MB | 54 B | 10 | 540 MB |
| SHOT_DATA | 512 | B | 512 B | 2048 | 1 MB |

The memory manager (206) supports time based fetch queries for data blocks for each data source. An administrator can query any data stream based on name and how many blocks are needed. Based on data size, unless otherwise requested, the memory manager (206) may return the actual data in cases where the data is small in size, or handle list and size information so the administrators can query the data themselves by accessing the shared memory in-stream data cache (212).

The memory manager (206) notifies (4) the control and notification module (208) of the type of data and where the memory is allocated. Also, the data ingestion manager (204) notifies the control and notification module (208) of the prioritization of the data streams as described above. The control and notification module (208) controls all the structures of the frame work, and sends notifications to a number of additional modules or components within the system (200). The notifications sent by the control and notification module (208) to other modules or components are sent when those modules or components need to analyze and process the data obtained from the sensor array (250).

The control and notification module (208) notifies (5) the data flow graph and scheduler (210). In seismic data processing or processing of any large amount of data, it is helpful to understand what data is being introduced into the system, and what type of analysis is to occur with respect to the data in order to achieve a desired output from the system. The data flow graph and scheduler (210) creates a flexible compute model, and allows for variability in how the data is analyzed by allowing for the creation of new analysis rules or the redesign and optimization of existing analysis rules that are used to provide a desired output. In one example, an administrator may change, via the data flow graph and scheduler (210), a number of algorithms the system (200) utilizes to produce this desired output. The data flow graph and scheduler (210) returns information to the control and notification module (208) describing how data is to flow through the system (200).

The data flow graph and scheduler (210) manages a default data flow graph and dynamic data flow graph for each data stream flowing into the system (200). A default data flow graph may dictate a flow of information between a number of connected operators (216-1, 216-2, 216-n) working in combination in parallel, sequence, or a combination thereof as will be described in more detail below. In one example, each operator (216-1, 216-2, 216-n) in the system is designated to exclusively perform a number of analytics with regard to the data received. Further, in another example, the output of one operator (216-1, 216-2, 216-n) may be connected to a number of other operators (216-1, 216-2, 216-n) using queue names at run time. The data flow graph and scheduler (210) statically creates data flow graphs, and supports the creation of a data flow graph for a data stream, adds, on demand, a number of operators (216-1, 216-2, 216-n) to the system (200) dynamically, and removes, on demand, a number of operators (216-1, 216-2, 216-n) from the system (200) dynamically.

In some situations, a client (240) may execute some operation which is not dependent on any data source; its execution is not tied to the notification of a data block coming into system (200). In this situation, the request is sent by a client interaction manager (CIM) (236) and the system (200) does not associate a default data flow graph. Instead, the system (200) associates a dynamic data flow graph for that purpose, and the data source name in such cases may be marked as “NONE.” The operators (216-1, 216-2, 216-n) get executed by operator manager (214) immediately, and the results are published to a queue of the CIM (236) based on the data flow graph configuration.

In another example, the system (200) may allow for the creation of new data flow graphs on the live system and allow changes to existing data flow graphs using a data flow graph editor as part of an administration application for a command center system (CCS) server. In this example, an administrative console may also allow an administrator to monitor the live health of the system (200) and make changes to system settings without restarting the server.

The control and notification module (208) notifies (6) the operator manager (214) of the type of data and where the memory is allocated as determined by the memory manager (206). In one example, the data stream is received into the system (200) and stored in the shared memory in-stream data cache (212). The data stream may comprise data associated with the health of the sensor array (250). This information is transmitted to the operator manager (214) in order to notify (6) the operator manager (214) of this information.

The operator manager (214) manages and controls (7) a number of operators (216-1, 216-2, 216-n). Although three operators (216-1, 216-2, 216-n) are depicted in FIG. 2, any number of operators (216-1, 216-2, 216-n) may be present within the system (200) in order to carry out any number of processes and data analysis as desired. The number of operators (216-1, 216-2, 216-n) within the system (200) may be scaled up or scaled down to accommodate for an increased demand or a decreased demand in processing power, or to accommodate for different types of processes.

The operator manager (214) utilizes a system configuration called “operator registry” containing information on what operators (216-1, 216-2, 216-n) exist in the system (200). The operator registry may comprise a number of properties including, for example, a “NAME” (e.g. op_clustering), an “INVOKE_PATH,” and a “TYPE” (e.g., “ALWAYS_ON” or “ON DEMAND”). The “ALWAYS_ON” operators are created automatically during initialization. Further, the operator manager (214) launches all mandatory or required operators (216-1, 216-2, 216-n) during startup and executes each data flow graph command message in a separate thread. The data flow graph command message comes in from control and notification module (208) as described above.

An Execute_DFG (i.e., execute data flow graph) command may comprise two data flow graphs associated therewith, namely, a default data flow graph and a dynamic data flow graph. Any request may comprise at least one of the above data flow graphs. A default data flow graph contains a data flow graph executing a set of operators in a sequence, involving a combination of operator chaining and parallel execution. In one example, support may be provided for the operator manager (214) by including the monitoring of operators (216-1, 216-2, 216-n), and the restarting of operators (216-1, 216-2, 216-n) if they have crashed or have become non-responsive for a predetermined amount of time. Further, support may be provided for the operator manager (214) by tracking usage of on-demand operator (216-1, 216-2, 216-n) processes if they have been idle.

In one example, the operators (216-1, 216-2, 216-n) may, alone, or in any combination, be used to process seismic data obtained from the sensors (252-1, 252-2, 252-n) and produce visualizations of the sensor array (250) for an administrator to view. The visualizations may provide the administrator with information regarding the health of the sensor array (250) and the quality of the data obtained from the sensors (252-1, 252-2, 252-n) within the sensor array (250) as described above. The operators (216-1, 216-2, 216-n) may read and obtain (7.1) data which is to be processed from the shared memory in-stream data cache (212). The operators (216-1, 216-2, 216-n) may also read and obtain (7.4) data which has already been processed by a number of the operators (216-1, 216-2, 216-n) from a key value store (234), as will be described in more detail below. In one example, the type, function, and configuration of the operators (216-1, 216-2, 216-n) is dependent on what type of sensors (252-1, 252-2, 252-n) are deployed in the sensor array (250).

To achieve their desired functionalities, the operators (216-1, 216-2, 216-n) may leverage (7.3) the compute resource management module (218) to analyze and process the data. The compute resource management module (218) comprises a number of general-purpose computing on graphics processing units (GPGPUs) (220), a number of multi-core central processing units (CPUs) (222), and a number of clusters (224). The GPGPUs (220) are graphics processing units (GPUs) that assist the operators (216-1, 216-2, 216-n) in performing computations. The data flow graph and scheduler (210), the operator manager (214), or other computing device within the system (200) may determine the amount of resources the operators (216-1, 216-2, 216-n) may leverage form the compute resource management module (218).

In one example, the system (200) may scale the number of GPGPUs (220) and multi-core CPUs (222) that may be leveraged by the operators (216-1, 216-2, 216-n) in performing computations within the system (200). This scaling of the number of GPGPUs (220) and multi-core CPUs (222) that may be leveraged may be a scaling up or a scaling down. Further, the number of GPGPUs (220) and multi-core CPUs (222) that may be leveraged may be scaled to accommodate for an increased demand or decreased demand in processing power, or to accommodate for different types of processes. This scaling may be performed in a dynamic manner as processing needs increase or decrease. The ability to scale the number of GPGPUs (220) and multi-core CPUs (222) leveraged by the operators (216-1, 216-2, 216-n) allows for the system to process extremely large amounts of data and accommodate for multiple sets of data from different sources (i.e. channels) to be linked and/or housed together as described above. The data may be analyzed using the present systems and methods to provide information about the multiple sets of data.

The multi-core CPUs (222) assist the operators (216-1, 216-2, 216-n) in reading and executing program code used to analyze the seismic data. As described above, the multi-core CPUs (222) may also be scaled based on system needs. The clusters (224) may comprise any number or types of computers that work together to further assist the operators (216-1, 216-2, 216-n) in processing and storing the seismic data, and, like the GPGPUs (220) and multi-core CPUs (222), may be scaled.

In one example, an operator (216-1, 216-2, 216-n) may receive, as input, data from a number of the other operators (216-1, 216-2, 216-n). In this example, an operator (216-1, 216-2, 216-n) may perform a number of operations or processes and output the processed data to a number of the other operators (216-1, 216-2, 216-n) as input to those other operators (216-1, 216-2, 216-n). In another example, a number of operators (216-1, 216-2, 216-n) may be chained together to perform a particular task. In this manner, the operators (216-1, 216-2, 216-n) may interact with one another to achieve a desired overall output.

The operator manager (214) also determines which of a number of the operators (216-1, 216-2, 216-n) are to be utilized for processing a particular data stream or mixture of data streams, and instructs those particular operators (216-1, 216-2, 216-n) to perform the functions those operators (216-1, 216-2, 216-n) are configured to perform. During processing of the data streams and other forms of data by the operator manager (214), operators (216-1, 216-2, 216-n), and compute resource management module (218), a number of temporary values may be written to and stored in (8) in the key value store (234). The key values stored in the key value store (234) are output from a number of the operators (216-1, 216-2, 216-n), and may be used as input for a number of the other operators (216-1, 216-2, 216-n) by the operator manager (214) or an operator (216-1, 216-2, 216-n) reading (7.4) the key values from the key value store (234). In this example, the key value store (234) is a temporary storage device that receives key values for later processing by the operator manager (214), operators (216-1, 216-2, 216-n), and compute resource management module (218). Thus, the system (200) is able to access data that is relatively frequently accessed from the key value store (234) with respect to data obtained from the shared memory in-stream data cache (212).

If values of final processing outputs are to be stored, these values may be stored to any type of database storage. In one example, data associated with the final processing outputs may be stored in the key value store (234), and the key value store (234) may send this data onto other devices such as the database operator (DBOP) (226). In another example, the DBOP (226) receives the data either directly from the operator manager (214) or operators (216-1, 216-2, 216-n), or indirectly from the key value store (234). The DBOP (226) assists in the transmission of the data representing final processing outputs to a number of other computing devices, and also assists in the storage (7.2) of the data representing final processing outputs to a number of other data storage devices. In one example, the DBOP (226) stores (7.5) data back to the shared memory in-stream data cache (212). The data stored in the shared memory in-stream data cache (212) may then be used again in further processing and analysis.

In another example, the DBOP (226) stores (7.2) data to an in-memory database (228). The in-memory database (228) may then write (11) the data to database (230) as new data or as an update to data existing in the database (230). In this example, the data stored at the database (230) may comprise system health data, quality control data, and seismic data associated with the detection of seismic events by the sensor array (250), among other forms of data. Further, the data stored at the database (230) may comprise historical data associated with the seismic events detected by the sensor array (250). This historical data may update previous seismic data in a periodic manner, or may be added to existing seismic data. The database (230) may be backed up (11.1) periodically by a backup database (232).

The output of the system (200) is presented to an administrator as a visualization at the command center (FIG. 1, 102). In one example, the output is sent to a client interaction manager (CIM) (236). The CIM (236) provides (12) the output data to a number of clients (240). The client are computing devices that provide to an administrator a user interface to interact with the system (200) as well as display the visualizations produced from the output of the system. The visualizations assist an administrator in managing a number of tasks associated with the seismic survey project such as, for example, monitoring locations of vibroseis truck, locations of the sensors (252-1, 252-2, 252-n), the health of a number of the sensors (252-1, 252-2, 252-n), the quality of the data obtained from the sensors (252-1, 252-2, 252-n), visual representations of the subterranean area (112) of the land, among other items of information. In one example, a number of applications may be executed on the clients (240) in order to produce the visualizations based on the data output from the system (200). In another example, the output of the system (200) is sent as a message from the CIM (236) to a number of the clients (240).

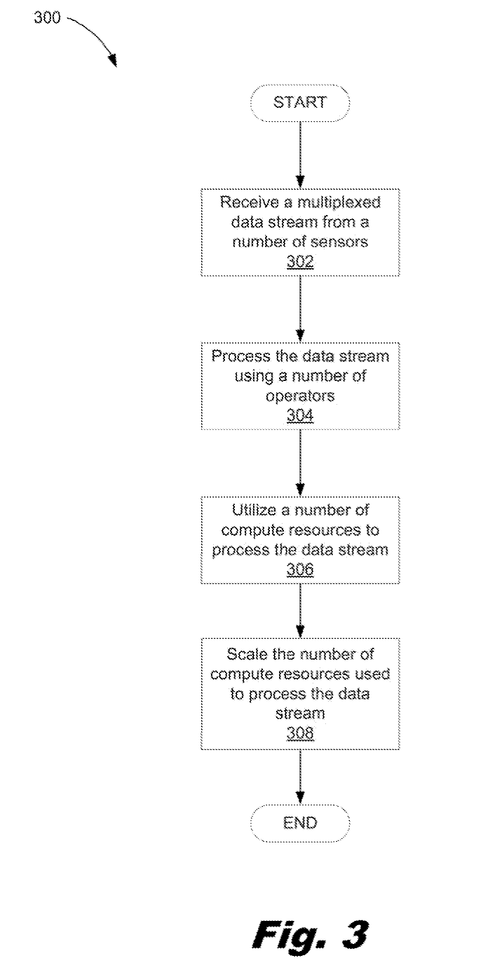

FIG. 3 is a flowchart showing a method of stream data processing, according to one example of the principles described herein. The method of FIG. 3 may begin by receiving (block 302) a number of data streams from a number of sensors (252-1, 252-2, 252-n). The data streams are processed (block 304) using a number of the operators (216-1, 216-2, 216-n).

As described above, the operators (216-1, 216-2, 216-n) may leverage the resources provided by the compute resource management module (218), and, specifically, a number of general-purpose computing on graphics processing units (GPGPUs) (220). Thus, the method continues with the operators (216-1, 216-2, 216-n) utilizing (block 306) a number of the GPGPUs to process the data streams.

The operator manager (214) or other computing device within the system (200) scales (block 308) the number of GPGPUs used to process the data streams. As described above in connection with FIG. 2, the number of GPGPUs (220) that may be leveraged may be scaled to accommodate for an increased demand or decreased demand in processing power, or to accommodate for different types of processes.

In one example, the system (200) may send a number of commands to a number of sensors (252-1, 252-2, 252-n) within the sensor array (250). In this example, the commands may comprise a request for data from the (252-1, 252-2, 252-n) in order to ascertain the status of a sensor (252-1, 252-2, 252-n), its health, its battery level, and the orientation of the sensor (252-1, 252-2, 252-n), among other items of information. Further, a number of commands may be sent between the command center (102), and base camp (104). In this manner, coordination within the survey process and allocation of resources therein may occur more quickly and efficiently.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, the operator manager (214), operators (216-1, 216-2, 216-n), or GPGPUs (220) of the system (220), or other programmable data processing apparatus, implement the functions or acts specified in the flowchart and/or block diagram block or blocks. In one example, the computer usable program code may be embodied within a computer readable storage medium; the computer readable storage medium being part of the computer program product.

The specification and figures describe systems and methods for processing data streams comprising receiving a multiplexed data stream from a number of sources, the sources comprising a number of sensors and a number of vibroseis trucks to stimulate an environment in which the sensors are deployed. The systems and methods also processes the data stream using a number of operators, and, with the operators, utilizing a number of compute resources to process the data stream. The systems and methods also, with a data flow graph and scheduler module, scale the number of compute resources used to process the data stream. This system and method may have a number of advantages, including: (1) providing for very high volume processing on the order of over 150 billion data points per day for deep analytics comprising analysis, diagnostics, and prognostics from approximately one million or more sensors compared to other Complex event processing (CEP) systems; (2) providing a platform for building field applications; (3) allowing operators to leverage GPGPU hardware to parallelize and execute algorithms efficiently; (4) supporting writing operators in multiple languages such as, for example, C++, Java, Perl, Python, among others, by design and can extend to any other language if needed; and (5) using a data flow graph for controlling data flow and operations within the system.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for processing data streams comprising:
receiving a multiplexed data stream from a number of sources, the sources comprising a number of sensors and a number of vibroseis trucks to stimulate an environment in which the sensors are deployed;
processing the data stream using a number of operators;
with the operators, utilizing a number of compute resources to process the data stream; and
with a data flow graph and scheduler module, scaling the number of compute resources used to process the data stream.

2. The method of claim 1, in which scaling the number of compute resources used to process the data stream comprises scaling a number of GPGPUs and multi-core CPUs used to process the data stream based on a workload received by the number of sources.

3. The method of claim 1, in which scaling the number of compute resources used to process the data stream comprises scaling up a number of compute resources, scaling down the number of compute resources, or a combination thereof.

4. The method of claim 1, in which the data stream comprises structured data, unstructured data, or a combination thereof.

5. The method of claim 1, in which the sources further comprise a number of applications, a number of personnel, a base camp, a command center, or combinations thereof.

6. A system for stream data processing comprising:
a sensor array to produce a number of data streams, the sensor array comprising a number of sensors, and the data streams comprising data associated with seismic activity and vibroseis truck vibrations detected by the sensors;
a number of operators to process the data streams;
a number of compute resources utilized by the operators to process the data streams; and
a data flow graph and scheduler module to scale the number of compute resources utilized by the operators to process the data streams.

7. The system of claim 6, in which the number of sensors within the sensor array is over one million.

8. The system of claim 6, further comprising a memory manager, in which the memory manager allocates a number of types of memory structures to which data within the data streams is stored.

9. The system of claim 6, further comprising a data flow graph and scheduler module to create a compute model,
in which the data flow graph and scheduler module may be updated with a number of new analysis rules, updated via redesigning of existing analysis rules, or a combination thereof.

10. The system of claim 6, further comprising a key value store for storing values output from a first operator of the number of the operators for processing by a second operator.

11. The system of claim 6, in which the sensors are microelectromechanical systems (MEMS) based accelerometers.

12. A computer program product for processing data streams, the computer program product comprising:
a computer readable storage medium comprising computer usable program code embodied therewith, the computer usable program code comprising:
computer usable program code to, when executed by a processor, instruct a number of operators to process a number of data streams obtained from a sensor array, the sensor array comprising a number of sensors, and the data streams comprising data associated with seismic activity and vibroseis truck vibrations detected by the sensors;
computer usable program code to, when executed by a processor, instruct the operators to utilize a number of general-purpose computing on graphics processing units (GPGPUs) to process the data streams; and
computer usable program code to, when executed by a processor, scale the number of GPGPUs used to process the data streams.

13. The computer program product of claim 12, in which the computer usable program code to, when executed by a processor, scale the number of GPGPUs used to process the data streams comprises computer usable program code to, when executed by a processor, dynamically scale the number of GPGPUs used to process the data streams based on the workload received.

14. The computer program product of claim 12, in which the computer usable program code to, when executed by a processor, scale the number of GPGPUs used to process the data streams comprises computer usable program code to, when executed by a processor, scale up the number of GPGPUs, scale down the number of GPGPUs, or a combination thereof.

15. The computer program product of claim 12, further comprising computer usable program code to, when executed by a processor, scale the number of operators used to process the data streams.
